(19) United States
(12) Patent Application Publication
(10) Pub. No.: US 2023/0035077 A1
(43) Pub. Date: Feb. 2, 2023

(54) EXTRUSION PRESS DEVICE, EXTRUSION PRODUCT, AND METHOD

(71) Applicant: Reto PATTIS, Scuol (CH)

(72) Inventor: Clemens PFEIFER, Imst (AT)

(21) Appl. No.: 17/791,622

(22) PCT Filed: Jan. 7, 2021
(86) PCT No.: PCT/EP2021/050174

§ 371 Date: Jul. 8, 2022

(30) Foreign Application Priority Data
Jan. 10, 2020 (DE) 20 2020 100 117.5

(51) Int. Cl. B27N 5/02; B29C 48/11; B29C 48/00; B27N 3/02; B27N 3/18; B27N 3/28

(52) U.S. Cl. CPC B27N 5/02; B27N 3/02; B27N 3/18; B27N 3/28; B29C 48/11; B29C 48/022; B29C 48/0022; B29C 2793/009; B29K 2511/14

(57) ABSTRACT

An extrusion press device (1) and a method are for an extrusion material (3) which has small loose plant parts, in particular wood chips, provided with binder. The extrusion press device (1) has an extrusion press (7) which presses the supplied loose extrusion material (3) and shapes same into a strand (8) and which advances the strand in an extrusion direction (9). The extrusion press (7) has a shaping device (21) which forms one or more inner tubular cavities in the strand (8) in the extrusion direction (9). The extrusion press (7) forms a continuous strand (8) with one or more inner tubular cavities (29) during the extrusion process, the cavities being closed by the extrusion material (3) at the end face.

### CROSS REFERENCE TO RELATED APPLICATIONS

This application is a United States National Phase Application of International Application PCT/EP2021/050174, filed Jan. 7, 2021, and claims the benefit of priority under 35 U.S.C. §119 of German Application 202020100117.5, filed Jan. 10, 2020, the entire contents of which are incorporated herein by reference.

### TECHNICAL FIELD

The present invention pertains to an extrusion press device, to an extrusion product and to a manufacturing process for material to be pressed, which has small loose plant parts provided with a binder, especially wood chips.

### TECHNICAL BACKGROUND

It is known from practice that perforated pallet blocks can be manufactured with an extrusion press device and that an inner tubular cavity that is continuous over the entire length of the strand can be formed in the strand in the process. The pallet blocks are manufactured from a loose pressed material, which contains loose small plant parts, especially small wood parts or wood chips, which are provided with a binder.

In addition, tubular particle boards, which likewise have inner tubular cavities, which are open at the end face and are continuous over the length of the board and which are manufactured from said pressed material, are known from practice in the area of particle boards.

### SUMMARY

An object of the present invention is to provide an improved extrusion technology.

The present invention accomplishes this object with features as described herein.

The extrusion technology according to the invention, i.e., the extrusion press device, the manufacturing process and the extrusion product, have various advantages.

The extrusion technology being claimed makes it possible to form a continuous strand, in which one or more inner tubular cavities are formed and which are closed by the pressed material at the end face. Said cavities are formed in the pressed material. The cavities are located in the interior of the strand. They may be encapsulated. The cavities may be empty or be filled with a medium, e.g., with an insulating material.

Extrusion products with said inner cavities and with closed end faces can be manufactured from the strand. A strand and an extrusion product may, however, also have one or more inner tubular cavities, which are continuous in the longitudinal or extrusion direction and which are open at one end face or at both end faces. These maybe called other cavities.

The extrusion products may have, e.g., the shape of a board. They may also have a different and optionally profiled shape. The extrusion products may be used as door leaves, shelves, inserts for multilayer boards or the like. A use for other purposes, e.g., as furniture parts, wall panels or the like, is generally possible was well.

The extrusion press device for said pressed material may have an extrusion press, which presses the loose material fed for pressing and shapes it into a strand as well as feeds it in an extrusion direction. The feed may take place continuously or preferably intermittently.

The extrusion press may have a shaping means, which forms one or more inner tubular cavities in the strand in the extrusion direction. A strand with one or more inner tubular cavities in the pressed material, which are closed by the pressed material at the end face, is formed during the extrusion. The shaping means can be activated and is movable and may be used or activated temporarily for forming the cavity during the extrusion. When the shaping means is not being used or is deactivated, this brings about the formation of a closure at the end face of the cavity during the extrusion. The extrusion press has a corresponding configuration and function and is especially controlled correspondingly for this purpose.

The extrusion press may also form a plurality of parallel strands. The extrusion direction may be oriented horizontally or vertically or even obliquely.

A strand, which has a massive strand area at one end face or at both end faces of the one or more inner tubular cavities, may be formed during the extrusion. The extrusion press may have a corresponding configuration and be controlled correspondingly for this purpose.

The one or more massive strand areas consist of said compacted pressed material. They also form the respective end-face closure of said tubular cavities. They may be oriented at right angles to the extrusion direction. The respective massive strand area may have a considerable thickness when viewed in the extrusion direction. It may mechanically stabilize the strand and the extrusion product in this area. A plurality of parallel inner tubular cavities may be closed at the end face by a massive strand area extending over an at least significant part of the width of the strand.

A strand, which contains a plurality of inner tubular cavities one behind another in the extrusion direction, may be formed during the extrusion. The strand may have a massive strand area each between inner tubular cavities following each other in the extrusion direction. The extrusion press is configured and controlled correspondingly for this purpose.

The massive strand area between a plurality of tubular inner cavities arranged one behind another may form, on the one hand, the respective end-face closure of these cavities. It may also form a compact and mechanically stable as well as transversely directed strand area from said pressed material between these cavities located at axially spaced locations. The thickness of the massive strand area may vary. The massive strand area may extend at least over a significant partial area of the strand width. A plurality of parallel inner tubular cavities may be closed at the end face by the massive strand area.

The extrusion products manufactured from the quasi endless strand, e.g., by cutting off may have a massive strand area at one or both end faces pointing in the extrusion direction and a massive and closed product wall formed hereby. This is favorable for the further processing of the extrusion product, e.g., for applying a veneer, for fastening attached parts or the like. In addition, the mechanical stability of the extrusion product is increased, especially in the area of the front wall and possibly on the longitudinal sides. An additional and stabilizing mounting frame, as it is used in prior-art door leaves comprising tubular particle boards, may be eliminated or may have a less complicated configuration.

A massive strand area may also be arranged at another location, e.g., at the longitudinal edges of the extrusion product. Such a massive strand area may be configured as a fitting area for receiving a fitting part. This may be, e.g., a lock or a mount of an extrusion product configured as a door leaf. It is especially suitable for fastening and for the stable mounting and supporting of such fitting parts. The one or more inner tubular cavities may be arranged for this purpose with a corresponding distribution in the strand. They may be located at a correspondingly widely spaced location especially from a side edge of the door leaf inwardly and possibly also from one another in the extrusion direction.

The massive and closed front walls of the extrusion product may be formed by a corresponding cross-cutting of the strand at a massive strand area. It is, however, also possible to cut off an extrusion product from the strand such that one or more inner tubular cavities are cut through and they form an open orifice at a front wall of the extrusion product. It is possible, in addition, to provide one or more inner tubular cavities passing over the entire length of the extrusion product and also of the strand, e.g., as continuous cable ducts or for receiving inserted reinforcing bodies or the like. These cavities may be open at one end face or at both end faces.

The cavities may be arranged in the strand and in the extrusion product in parallel next to one another and mutually at the same level when viewed in the extrusion direction. It is also possible to arrange said inner tubular cavities with a mutual offset, especially with an axial offset in the extrusion direction.

Such inner tubular cavities, which are closed at the end face, may have an equal length among one another in the extrusion direction. As an alternative, they may have different lengths. Said cavities may have both different lengths and said offset. The inner tubular cavities have a straight course in the extrusion direction. They are embedded in the strand and in the pressed material. Some of these cavities may be arranged in the strand and in the extrusion product as desired and in any desired combination.

The extrusion press may have a filling and pressing space for receiving and pressing the loose material fed for pressing. Said shaping means may temporarily be inserted into the filling and pressing space and also temporarily removed again. The shaping means inserted extends in the extrusion direction in the filling and pressing space. It preferably extends over the entire length of the space. It may also extend beyond the boundary of the space into an adjacent pressing duct.

The shaping means inserted into the filling and pressing space is used to form the one or more internal tubular cavities. The material to be pressed, which is located in the filling and pressing space, encloses the shaping means. The material to be pressed is fed during the extrusion in the extrusion direction and is compacted and pressed in the process, and said one or more internal tubular cavities are formed in the pressed material. New material to be pressed is pressed again and again onto the existing strand during the formation of the strand while extrusion sections are formed and the strand is fed by a corresponding stroke length in the extrusion direction.

When the shaping means is removed from the filling and pressing space, this space can be filled completely with the material to be pressed. As a result, an end-face closure of one or more inner tubular cavities formed beforehand or thereafter can be formed. The shaping means can also be removed from the filling and pressing space partially or at some locations and the filling and pressing space can correspondingly be filled partially or at some locations with the material to be pressed.

The shaping means can be temporarily inserted into the filling and pressing space by means of a feeding device and it can also be temporarily removed therefrom. This may be carried out in different manners. In a preferred embodiment, the feeding device moves the shaping means in the extrusion direction and drives same in a controlled manner in the process.

The shaping means may have any desired and suitable configuration. In an advantageous embodiment, it has one or more mandrels, which are directed in the extrusion direction. The mandrels may have a straight course and any desired cross-sectional shape and cross-sectional size. They may be hollow or massive on the inside. Their outer contour may have any desired shape, e.g., circular, oval, prismatic, etc.

The one or more mandrels may be movable, especially in the extrusion direction. They may also be moved along during the extrusion. A plurality of mandrels may be arranged and controlled such that they can be moved together. In an advantageous embodiment, a plurality of parallel mandrels may be arranged and controlled such that they are movable independently from one another. The shaping means may as a result also be removed partially or at some locations from the filling and pressing space.

This makes possible the formation of inner tubular cavities, which differ in terms of their length and/or their arrangement in the strand. In particular, it is possible to form an offset.

One or more mandrels may have a tubular configuration in the above-mentioned manner. They may be configured such that they can be closed or are closed at the end face. Tubular mandrels make it possible to insert a medium during the extrusion into the inner tubular cavities formed. Such a medium may be, e.g., steam or another heat transfer medium. Further, other media, e.g., a fluidic or granular insulating material or an insulating material having another form may be inserted into said cavity or said cavities. An end-face mandrel closure prevents the entry of pressed material during the formation of an end-face closure or of a said massive strand area.

The extrusion press may have a driven pressing element, which presses the loose material to be pressed and feeds same in the extrusion direction. This preferably takes place intermittently. It may also take place continuously as an alternative. In an advantageous embodiment, the extrusion press is configured as a piston rod press, with which the material to be pressed is fed and pressed intermittently in the extrusion direction. In another embodiment, an embodiment as an extruder with a screw or the like is possible, which feeds and presses the loose material to be pressed continuously or likewise intermittently in the extrusion direction.

In a preferred embodiment, the pressing element has a reversing driven press head with a press punch oriented in the extrusion direction. The press punch can dip into the filling and pressing space. It can also be removed therefrom again for filling the material to be pressed. In a variant, a press head and/or a press punch may be present in a divided form or as a plurality of press heads and/or press punches.

In an advantageous embodiment of the extrusion press, the shaping means is arranged in or at the press punch. It can enter and exit reversingly in this case. Further, it is favorable if the feeding device is arranged at the press head. As an alternative, it may be arranged independently and stationarily. The shaping means is arranged movably in or at the press punch. It may project forward over the front wall of the press punch in the extrusion direction or end at the front wall. The front wall is located in the front in the extrusion direction and acts on the material to be pressed, which is present in the filling and pressing space for feeding and pressing said material. The front wall may have a flat or profiled shape. It may be oriented at right angles, especially perpendicularly, to the extrusion and feed direction.

The strand is also moved in the extrusion direction during the feed of the pressed material. The pressing and compaction of the loose material being pressed takes place by braking the strand in relation to the feed motion of the loose material being pressed. The braking effect can be generated in a pressing duct adjoining the filling and pressing space with a corresponding internal shaping and/or by a treatment device arranged downstream in the extrusion direction.

The extrusion press has a feeding device for the loose material to be pressed. The feeding device may have a metering device for the loose material to be pressed. This can control the filling of the filling and pressing space as a function of the absence or lack of the shaping means in the filling and pressing space. When a shaping means is present, a smaller quantity of material to be pressed can be inserted into the filling and pressing space than when the shaping means is not present due to the space required for the shaping means. The metering device and possibly the feeding device may be actuated and operated correspondingly by means of the control of the extrusion press.

The extrusion press may have a feed-side closing device for the filling and pressing space. The closing device closes the feed-side filling opening for the material to be pressed. The closing device may have any desired and suitable configuration, e.g., a configuration as a closing slide. This can be moved by a translatory and/or rotatory movement for closing and opening. It may also be equipped with a conveying device for supporting the filling with the loose material to be pressed.

The filling and pressing space is open on the end faces seen in the extrusion direction. The rear end face points towards the pressing element and the front end face towards an adjoining pressing duct. The other side walls of the filling and pressing space may have a massive and rigid configuration. As an alternative, retractable press punches, shaping means or the like may be arranged here as needed. These can influence the material being pressed, which is contained in the filling and pressing space, in a shaping manner on one or more of its outer sides.

The extrusion press device may have a treatment device arranged downstream of the extrusion press. This treatment device may contain, e.g., an activating or curing device and/or a cooling device preferably arranged in the extrusion direction.

The binder present in the pressed material can be activated in an activating or curing device in order to strengthen the strand and the compacted pressed material. The activating or curing device may be, e.g., a steaming device, a high-frequency heater, a microwave heater or a convection heating device or the like for the strand. The activating or curing device may also be configured depending on the type of the binder. The cooling device makes possible a cooling of the previously heated strand, which can be brought about by air, by cooling elements or the like.

The treatment device may be located at the pressing duct, in which the strand is being guided in the extrusion direction. The treatment device may also bring about a controlled braking of the strand, e.g., by one or more movable side walls of the pressing duct, which can be pressed on in a controlled manner, or by other breaking devices.

The extrusion press device may have a cutting device arranged downstream of the extrusion press for the strand. The strand being produced by the extrusion press in a quasi-endless form can be cut with the cutting device. Said extrusion product can be formed by the cutting of partial areas of the strand.

A cutting may be carried out in a direction at right angles to the extrusion press device. This includes an orientation of the extrusion press device at right angles or obliquely. It is, in addition, possible to perform a cutting of the strand along the extrusion direction. This includes an orientation in parallel or obliquely to the extrusion direction. A plurality of extrusion products with respective smaller front surfaces can be cut off by such a so-called lengthwise cutting from a strand having a large front surface.

The cutting device may be controlled in an advantageous embodiment such that the cutting of the strand is carried out at a massive strand area. This may pertain especially to said cross-cutting of the strand at right angles to the extrusion direction. The cutting may take place in a massive area of the strand located between parallel inner tubular cavities in case of a so-called lengthwise cutting.

The extrusion press device may have a processing device arranged upstream of the extrusion press for the material being pressed. The processing device may have a size reduction device for larger particles of pressed material. The pressed material is preferably formed from wood. The wood may be fresh wood, especially sawing waste, or possibly processed wood waste. As an alternative or in addition, other plant parts and preferably more or less dimensionally stable parts, e.g., plant stalks, straw or the like may be used. The pressed material may also contain further ingredients in addition to these parts.

The processing device may have a device for setting the particle size, a drying device or other components. The processing device may have, in addition, a device for inserting said binder, e.g., in the granulated or liquid form, into the loose material to be pressed.

Further advantageous embodiments of the present invention are described herein.

The present invention is shown in the drawings as an example and schematically. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a schematic view showing an extrusion press device with an extrusion press and with additional components in a side view;

FIG. 2 is a schematic cut-away and partially opened top view of the extrusion press according to arrow II in FIG. 1;

FIG. 3 is a schematic view showing the extrusion press according to FIG. 2 in one of different operating positions and alternative embodiments;

FIG. 4 is a schematic view showing the extrusion press according to FIG. 2 in another of different operating positions and alternative embodiments;

FIG. 5 is a schematic view showing the extrusion press according to FIG. 2 in another of different operating positions and alternative embodiments;

FIG. 6 is a schematic cut-away perspective view of a strand and of an extrusion product;

FIG. 7 is a schematic view showing one of different cross-sectional variants of the strand;

FIG. 8 is a schematic view showing another of different cross-sectional variants of the strand;

FIG. 9 is a schematic view showing another of different cross-sectional variants of the strand;

FIG. 10 is a schematic view showing one of different variants for configuring and arranging inner cavities in the extrusion product;

FIG. 11 is a schematic view showing another of different variants for configuring and arranging inner cavities in the extrusion product.

### DESCRIPTION OF PREFERRED EMBODIMENTS

Referring to the drawings, the present invention pertains to an extrusion press device (1), to an extrusion product (2) and to a manufacturing process for the extrusion product (2).

The extrusion product (2) is produced from a continuous strand (8) by means of the extrusion press device (1). The present invention also pertains to a related use of the extrusion press device (1).

FIG. 1 illustrates as an example the configuration of an extrusion press device (1). It is used to form a continuous strand (8) from a loose pressed material (3). The pressed material (3) contains small loose plant parts, especially small wood parts or wood chips, which are provided with a binder.

The loose material to be pressed (3) is pressed, compacted and strengthened by activating the binder during the extrusion while the strand (8) is formed. New material to be pressed (3) is pressed, e.g., intermittently onto the existing strand (8) on the rear side during the extrusion, and consecutive compacted extrusion sections (20) are formed in the process. The continuous strand (8) is made longer hereby and is fed each time by a stroke corresponding to the thickness of the extrusion sections (20) in the extrusion direction (9).

The extrusion press device (1) shown in FIG. 1 has a processing device (4) for the material to be pressed (3), an extrusion press (7) and a downstream cutting device (11) for the strand (8). A treatment device (10) for the strand (8) may also be arranged downstream of the extrusion press (7). Further, a control (27) is present. It can control the components of the extrusion press device (1), especially the extrusion press (7).

The processing device (4) has, e.g., a size reduction device for fresh wood or wood waste, with which wood particles, especially wood chips, which have the same or preferably different particle sizes, are produced. These are then dried. A binder is added in the processing device (14) to the wood particles or wood chips, e.g., in the dry form as a powder or granules or is sprayed on them in the liquid form. The binder may be, e.g., a hot-curing adhesive, e.g., a melamine resin, a phenolic resin, a urea resin, an isocyanate or the like. A binder may also be based on starch and/or sugar and/or other carbohydrates and/or lignin. The binder may release water or other liquids during the curing or polymerization, e.g., in a Maillard process.

The extrusion press (7) has a feeding device (5) with a metering device (6) for the loose particulate material being pressed (3) and a filling and pressing space (12) for receiving the material to be pressed (3), which is inserted, e.g., from the top through a filling opening. The filling opening of the filling and pressing space (12) may be temporarily closed by a closing device (14) for pressing and feeding the material being pressed (3). The closing device (14) may be configured as a reversingly movable closing slide, e.g., as a pivoting slide. The closing device (14) may have conveying devices, e.g., rotating paddles, which support the filling of the space with loose material to be pressed (3).

The extrusion press (7) further has a movable pressing element (15) driven in a controlled manner as well as a shaping means (21) along with a feeding device (24) for the shaping means (21).

The extrusion press (7) produces from the material being pressed (3) a strand (8), which is formed in an extrusion direction (9) and is fed in this direction out of the filling and pressing space (12) through an adjoining press duct (13). The side walls of this duct form the outer contour of the strand (8). FIGS. 7 through 9 show different shapes of the cross section and of the outer contour of the strand (8). The feed may take place continuously or preferably intermittently.

The pressing element (15) has a press head (16) driven reversibly by a press drive (19) with a press punch (17) arranged thereat at the end face. The press punch (17) is oriented in the extrusion direction (9) and has a front wall (18), with which the press punch (17) can dip into the filling and pressing space (12) through a rear opening in the space. The press head is configured, e.g., as a supporting beam configured, e.g., at right angles to the extrusion direction (9). It is acted on on the rear side by the preferably stationary press drive (19) with, e.g., two cylinders located at laterally spaced locations and is driven reversingly. The extrusion press (7) is configured as a piston rod press in this embodiment. The press drive (19) may have, as an alternative, an electric motor-driven linear drive, a crank drive or the like.

The shaping means (21) is arranged in or at the press punch (17) in a reversibly extendable manner. It is moved forward and backward by a feeding device (24) in the extrusion direction (9).

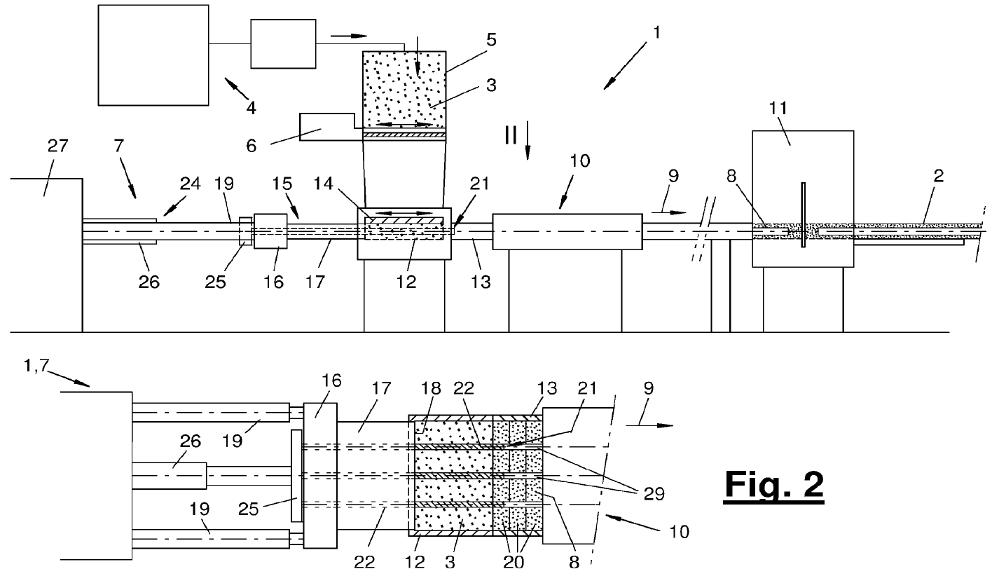

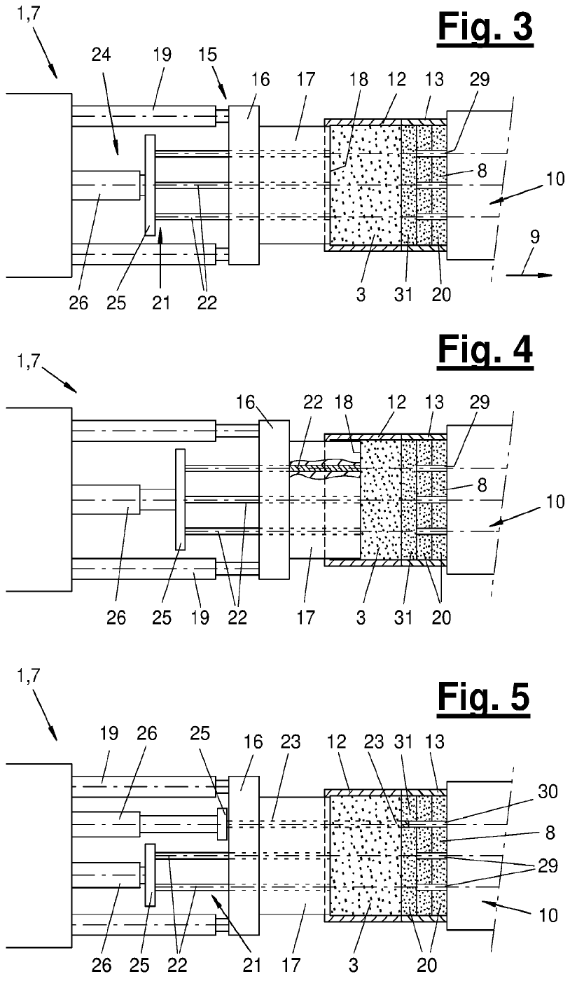

The shaping means (21) can be extended through and from the press punch (17) in the extrusion direction (9) and project over the front wall (18) of said press punch according to FIG. 2. The shaping means (21) can, on the other hand, be retracted into the press punch (17) according to FIG. 3. Then, it does not project from the front wall (18) any longer and can close flush with this wall. The press punch (17) may have corresponding mounting openings for the shaping means (21).

The shaping means (21) has, e.g., one or preferably more massive or hollow as well as straight mandrels (22, 23) oriented in the extrusion direction (9). A hollow mandrel (22, 23) may have at the end face a fixed closure or a closure movable in a controlled manner for the mandrel opening. The respective mandrel (22, 23) has a dimensionally stable wall.

The one or more mandrels (22, 23) maybe arranged each in a mounting opening of the press punch (17). They may move together, especially synchronously, with the press punch (17) during the extrusion. They may also be run over by the press punch (17). Further, another relative movement in relation to the press punch (17), e.g., a retracting movement of a mandrel (22, 23) during the press feed of the press punch (17), is possible.

The shaping means (21) may further have a mold holder (25), at which one or more mandrels (22, 23) are fastened at the end face and protrude in the extrusion direction (9). The feeding device (24) has a controllable drive (25), e.g., a cylinder, which moves the mold holder (24) reversingly forward and backward in the extrusion direction (9). The feeding device (24) is arranged independently and stationarily in FIG. 1. As an alternative, it may be arranged at the press head (16) and be carried along during the movements of said press head.

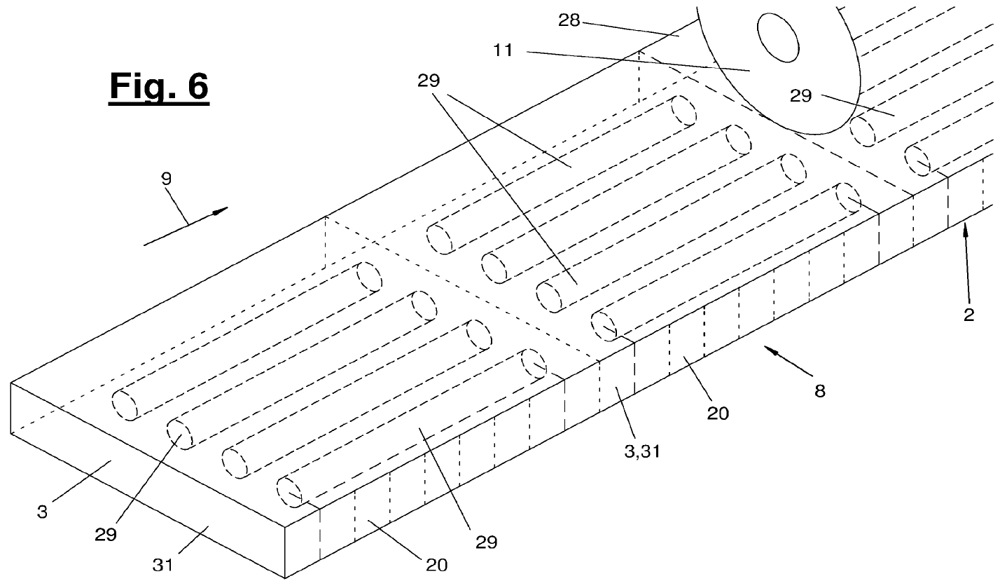

As is illustrated in FIGS. 1 through 4, the shaping means (21) may have a single mold holder (25) with a plurality of parallel mandrels (22). An alternative embodiment, in which the shaping means (21) has two or more mold holders (25) movable separately from one another and independently, is shown in FIG. 5. For example, two parallel mandrels (22) are arranged at one mold holder (25). The second mold holder (25) carries a single mandrel (23). The plurality of mold holders (25), e.g., two mold holders (25), have each a separate and independently controllable drive (26).

The shaping means (21) configured, e.g., in the above-mentioned manner by the one or more mandrels (22, 23) or in another manner is inserted temporarily into the filling and pressing space (12) and is temporarily also removed again from the filling and pressing space (12). The shaping means (21), especially the one or more mandrels (22, 23), have a length that corresponds to the length of the filling and pressing space (12) in the extrusion direction (9) or is greater than this length.

The inserted shaping means (21) is used to form one or more inner tubular cavities (29) during the extrusion. These cavities (29) are arranged within the strand (8) and have a straight shape extending along the extrusion direction (9). The loose material to be pressed (3), which is inserted into the filling and pressing space (12), fills the shaping means (21), especially the one or more mandrels (22, 23), during the extrusion, and is fed during the pressing feed of the pressing operation along the shaping means (21) and is pushed into the pressing duct (13) adjoining in the extrusion direction (9).

When the shaping means (21), especially the one or more mandrels (22, 23), are removed from the filling and pressing space (12), this can be filled completely with material to be pressed (3). The metering device (6) correspondingly controls the quantity of filling of the inserted material to be pressed (3).

FIG. 2 shows in a top view the filling space (12) with an inserted shaping means (21), wherein the press punch (17) is retracted into the inoperative position and the shaping means (21) projects on the front side from the front wall (18) into the filling and pressing space (12). Said extrusion sections (20) with said cavities (29) are formed during the extrusion. The press punch (17) runs over the shaping means (21), which is, for example, stopped, especially the one or more mandrels (22, 23), during the pressing feed in the extrusion direction (9).

FIG. 3 shows the arrangement according to FIG. 2 with a retracted shaping means (21) and with a press punch (17) in the inoperative position. The shaping means (21) is closed flush, e.g., at the end face with the front wall (18). The filling and pressing space (12) is empty and can be filled completely with loose material to be pressed (3).

When the press punch (17) is then moved according to FIG. 4 in the extrusion direction (9), the loose material to be pressed (3) is compacted and pressed to the strand (8) on the rear side. The shaping means (21), especially the one or more mandrels (22, 23), can be moved along during the feed of the press punch (17). A closed front wall (18) is formed in the process. FIG. 4 shows an intermediate position of the press punch (17) over its feed path to the front end of the filling and pressing space (12).

With a shaping means (21) retracted or deactivated, an extrusion section (20) is formed, which represents a massive strand area (31). The massive strand area (31) can be pressed according to FIGS. 3 and 4 onto an extrusion section (20) formed before with one or more cavities (29) and it then closes due to its massive shape the rearward front end of the one or more inner tubular cavities (29).

In the embodiment according to FIG. 5 with a multipart shaping means (21), especially with a plurality of separately movable mandrels (22, 23), e.g., the mandrel (23) is extended and is inserted into the filling and pressing space (12), wherein the other mandrels (22) are retracted and are removed from the filling and pressing space (12). An extrusion section (20), which has, e.g., an axially continuous inner tubular cavity (30) and has otherwise a massive configuration, is formed in such a configuration during the feed of the press punch (17). The configuration and the actuation of the shaping means (21), especially of the mandrels (22, 23), may vary, differing from the exemplary embodiment shown, and the number and the arrangement of separately movable mandrels (22, 23) or other components of a shaping means (21) may be modified.

An extrusion section (20) with one or more inner tube-like cavities (29) is formed again when the shaping means (21), especially the mandrels (22), are again extended according to FIG. 2 and are temporarily inserted into the filling and pressing space (12) starting from the strand formation according to FIGS. 3 and 4 during the next press stroke and feed of the press punch (17).

FIG. 6 illustrates this configuration of a strand (8) and of an extrusion product (2) produced herefrom. A plurality of inner tubular cavities (29), which are closed at the end face, are arranged in the strand (8) one behind the other at axially spaced locations when viewed in the extrusion direction (9), a massive strand area (31) each, consisting of pressed material (3) being located between these cavities (29) following one another. FIG. 6 also illustrates the extrusion sections (20) preferably formed intermittently. The massive strand area (31) is formed, e.g., by two massive strand sections (20) following one another. This number may vary upward and downward.

The treatment device (10) is arranged downstream of the extrusion press (7) in the extrusion direction (9). It is located at the pressing duct (13) and may have different configurations.

The treatment device (10) may have, for example, a device for activating or curing the binder in the pressed material (3), which device is arranged, e.g., in FIG. 1 directly downstream of the extrusion press (7) or at a short distance downstream of the extrusion press (7). This device may be, for example, a steam treatment device, a high-frequency heater or another device for introducing heat into the strand (8). Saturated steam or high-pressure steam can be introduced into the strand (8) from outside during the steam treatment and it may possibly condense here. A high-frequency heater is especially suitable for an organic binder of the type mentioned. The binder is cured or polymerized by the introduction of heat. Other types of binders may be activated in a different manner.

The treatment device (10) may have a cooling device for the strand (8). This cooling device may be arranged, e.g., downstream of the activating or curing device in the extrusion direction (9). The strand (8) heated before during the activation or curing is again cooled here. The cooling may be brought about by feeding air or by active cooling elements, e.g., water-cooled duct walls or the like.

The treatment device (10) may have a braking device for the strand (8). This braking device may be formed, e.g., by movably arranged side walls of the pressing duct (13) or by controllable feeding means. These are controlled such that the strand (9) is temporarily braked for pressing on and compacting an extrusion section (20) and is then released again, so that the pressing element (15) can push the strand (8) farther and move the compacted extrusion section (20) out of the filling and pressing space (12).

The treatment device (10) may have one or more additional components. These may be, for example, measuring devices for the strand density, for the moisture content of the strand or for other parameters of the strand. Further, an application device for applying a surface coating, e.g., a lacquer, to the strand (8) may be present. Furthermore, a measuring device for measuring the feed of the strand may be present. Such a measuring device may also be associated with the cutting device (11).

The cutting device (11) cuts off the strand (8) at axially spaced locations with a suitable cutting means, e.g., with a circular saw blade, with a saw band or the like and forms one or more extrusion products (2) in the process. The cutting may be carried out by a parting cut or in another manner, e.g., by jet cutting, erosion or the like. The cutting of the strand (9) takes place in a direction at right angles to the extrusion direction (9), wherein the strand (8) is cut through. Extrusion products (2), which have the same cross-sectional shape and cross-sectional size as the strand (8), are cut out of the strand (8) in the process. The extrusion products (2) cut off from the continuous strand (8) maybe separated, checked and removed with a conveyor.

The cutting device (11) may be controlled such that the cutting off always takes place according to FIG. 6 at a massive strand area (31). The extrusion product (2) obtained in the process will have as a result, when viewed in the extrusion direction (9), massive and, e.g., closed end faces as well as one or more encapsulated, tubular cavities (29), which are arranged in the interior of the body (28) of the extrusion product (2). The control may be carried out as a function of the strand feed.

The strand (8) and the extrusion product (2) may have any desired and suitable cross-sectional shape. The strand (8) and the extrusion product (2) may have, e.g., a board-like configuration, their width in the cross section being greater than their height. The strand (8) and the extrusion product (2) may have flat or profiled outer walls.

The cutting means (11) may also bring about, in addition to a cross-cutting, longitudinal cutting of the strand (8) along the extrusion direction (9) or along the axis of the strand. Such a parting cut may be directed upright or vertically and/or horizontally. A plurality of extrusion products (2), which have each a smaller cross-sectional size, can be cut off from the strand (8) having a given cross-sectional size by such a lengthwise cutting. FIG. 7 shows this embodiment.

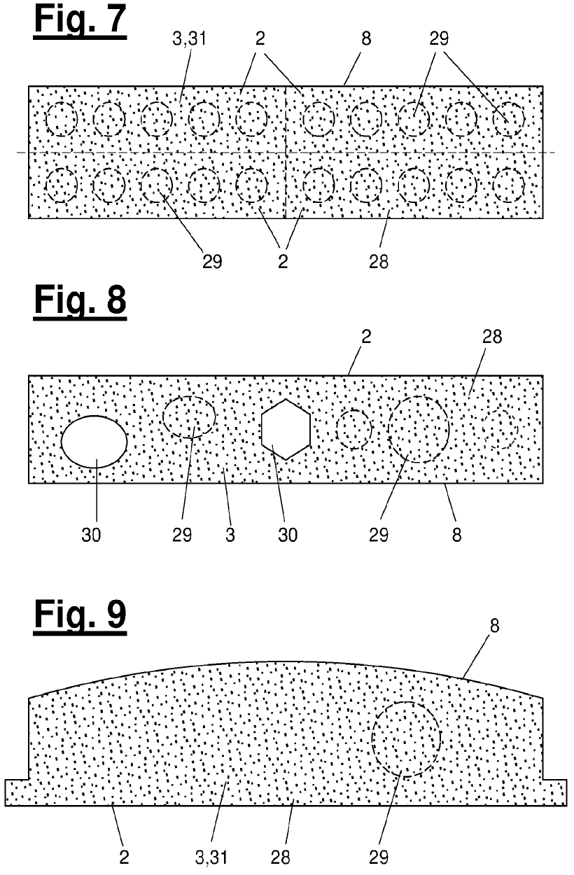

Said inner tubular cavities (29), which are closed at the end face, or continuous cavities (30) may be arranged in any number and at any desired location in the body (28) of the strand (8) and of the extrusion products (28) of the strand (8) and of the extrusion products (2). The cross-sectional shape of these cavities (29, 30) may likewise be selected as desired. FIG. 8 shows different embodiments in terms of the cross-sectional shape and position of such cavities (29, 30).

FIG. 9 shows a strand (8) and extrusion products (2) with profiled side walls. To form this cross-sectional profiling, the filling and pressing space (12) as well as the pressing duct (13) may have a corresponding configuration.

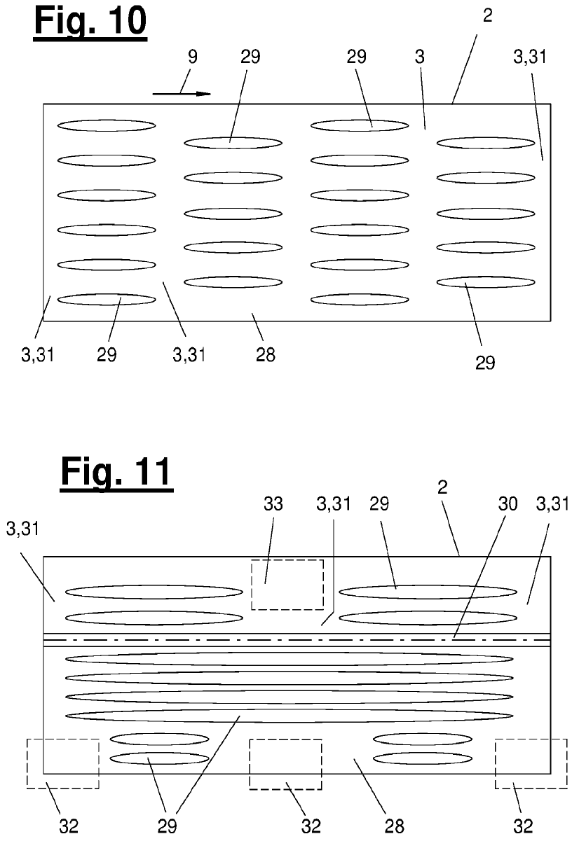

FIGS. 10 and 11 show preferred embodiments of an extrusion product (2). This has, e.g., an oblong and rectangular cuboid shape. It may be configured, e.g., as a door leaf.

FIG. 10 shows a varying arrangement of inner tubular cavities (29), which are closed at the end face. A plurality of such cavities (29) are arranged one behind another here in the longitudinal direction of the extrusion product (2) or in the extrusion direction (9). In addition, a plurality of these cavities (29) are arranged at right angles hereto next to one another. The cavities (29) have mutually an axial distance between them and also a lateral offset. Respective massive strand areas (31) consisting of pressed material (3) are arranged between the respective cavities (29) arranged one behind another. Massive strand areas (31) are located, in addition, at the end-face ends and also at the longitudinal sides of the extrusion product (2). A massive area consisting of pressed material (3) is likewise arranged between the parallel cavities (29).

FIG. 11 shows another variant, in which different inner tubular cavities (29), closed at the end face, are arranged with an offset in the body (28). The cavities (29) differ in their length and optionally also in their cross-sectional shape. FIG. 11 shows, in addition, an individual inner, tubular cavity (30), which is continuous over the entire length of the product and is open at both end faces.

According to FIG. 11, the inner, tubular cavities (29), which are closed at the end face, may be arranged in such a distribution that massive strand areas, which are suitable for use as fitting areas (32, 33), are formed at the extrusion product (2). The cavities (29) closed at the end face may be located for this purpose, e.g., at correspondingly spaced locations in the axial direction. The fitting areas (32) maybe located, e.g., at a longitudinal edge of the extrusion product (2) or door leaf with a distributed arrangement. They may be used for mounting door hinges or other mounts. A fitting area (33) arranged, e.g., on the other longitudinal side may be arranged axially in the middle area of the door leaf and maybe used, e.g., for mounting a door lock.

Various variants of the embodiments described and shown are possible. In particular, the features of the above-described embodiments and of said variants maybe combined and possibly also replaced with one another in any desired manner within the framework of the claims.

The shaping means (21) may have, as an alternative, one or more extendable drills or form subsequently a respective inner tubular cavity (29, 30) in an extrusion section (20). In another variant, dimensionally unstable devices, which have, if necessary, a variable cavity-forming volume e.g., inflatable hoses or the like, may be used instead of the above-described, dimensionally stable mandrels (22, 23).

The feeding device (5) may feed in one variant different types of material to be pressed (3) to the filling and pressing space (12). The differences maybe in different particle sizes, different materials or the like. A stratification may take place in the filling and pressing space (12) during the feed of the material to be pressed (3). The feeding device (5) may be correspondingly adapted for this purpose in terms of configuration and functionally. When the closing device (14), especially a closing slide, is actuated at the feeding device for the material to be pressed, it may also be configured and controlled correspondingly, e.g., by arranging a plurality of closing slides, which are each specific to the material to be pressed.

While specific embodiments of the invention have been shown and described in detail to illustrate the application of the principles of the invention, it will be understood that the invention may be embodied otherwise without departing from such principles.

### LIST OF REFERENCE NUMBERS

1 Extrusion press device
2 Extrusion product
3 Pressed material, material to be pressed
4 Processing device for material to be pressed
5 Feeding device for material to be pressed
6 Metering device
7 Extrusion press
8 Strand
9 Extrusion direction
10 Treatment device
11 Cutting device, saw
12 Filling and pressing space
13 Pressing duct
14 Closing device, closing slide
15 Pressing element
16 Press head
17 Press punch
18 Front wall
19 Press drive, cylinder
20 Press section, stroke section
21 Shaping means
22 Mandrel
23 Mandrel
24 Feeding device for shaping means
25 Mold holder
26 Drive, cylinder
27 Control
28 Body
29 Cavity, closed
30 Cavity, open
31 Strand area, massive
32 Fitting area
33 Fitting area

1. An extrusion press device for material to be pressed, which has small loose plant parts provided with a binder, the extrusion press device comprising:
an extrusion press, which presses the loose material to be pressed, which is fed, and forms the loose material into a strand and feeds the loose material in an extrusion direction during an extrusion; and
a shaping means, which forms one or more inner tubular cavities in the strand in the extrusion direction, wherein the extrusion press is configured to form, during the extrusion, the strand as a continuous strand with one or more inner tubular cavities, which are closed by the pressed material at the an end face of the continuous strand.

2. An extrusion device in accordance with claim 1, wherein the continuous strand has a respective massive strand area at one end face or at both end faces of the one or more inner tubular cavities.

3. An extrusion device in accordance with claim 1 , wherein the extrusion press is configured to form, during the extrusion, the continuous strand, which has a respective massive strand area between inner tubular cavities following one another in the extrusion direction (9).

4. (canceled)

5. An extrusion device in accordance with claim 1, wherein the extrusion press comprises a filling and pressing space for receiving and pressing the loose material to be pressed, which is fed.

6. An extrusion device in accordance with claim 5, wherein the extrusion press has a feeding device, which temporarily inserts the shaping means, during the extrusion, into the filling and pressing space to form a cavity of the one or more inner tubular cavities and temporarily removes same from the filling and pressing space to close the cavity.

7. An extrusion device in accordance with claim 6, wherein: the feeding device drives the shaping means in the extrusion direction reversingly and in a controlled manner; and the shaping means comprises one or a plurality of mandrels oriented in the extrusion direction.

8. (canceled)

9. An extrusion device in accordance with claim 7, wherein the plurality of mandrels are configured and arranged to be moved and controlled independently from one another.

10. An extrusion device in accordance with claim 7 , wherein one or more mandrels are configured to be tubular and to be closed or are closed at the end face.

11. An extrusion device in accordance with claim 5, wherein: the extrusion press has a driven pressing element, which presses the loose material intermittently and feeds the loose material in the extrusion direction; and the pressing element has a reversingly driven press head with a press punch, which is oriented in the extrusion direction and is configured to dip into the filling and pressing space.

12. (canceled)

13. An extrusion device in accordance with claim 11, wherein the shaping means is arranged in a reversibly extendable manner in or at the press punch.

14. (canceled)

15. An extrusion device in accordance with claim 5, wherein: the extrusion press has a feeding device configured to feed the loose material to be pressed; and the feeding device comprises a metering device for the loose material being pressed, which controls the filling of the filling and pressing space as a function of a presence or the absence of the shaping means in the filling and pressing space.

16. (canceled)

17. An extrusion device in accordance with claim 5, wherein the extrusion press comprises a feed-side closing device for the filling and pressing space.

18. (canceled)

19. An extrusion device in accordance with claim 1, wherein the extrusion press device comprises a cutting device for the strand, which cutting device is arranged downstream of the extrusion press, the cutting device being controlled such that cutting of the strand takes place at a massive strand area.

20-21. (canceled)

22. An extrusion product made from an extruded pressed material, which has small plant parts provided with a binder, the extrusion product comprising:
one or more inner tubular cavities, which are oriented in an extrusion direction (9), wherein the extrusion product has one or more inner tubular cavities, which are closed at the end face by the pressed material.

23. An extrusion product in accordance with claim 22, wherein:
the extrusion product has a respective massive strand area at one or both end faces of the one or more inner tubular cavities; or
the extrusion product has a respective massive strand area between inner tubular cavities following one another in the extrusion direction; or
the extrusion product has both a respective massive strand area at one or both end faces of the one or more inner tubular cavities and a respective massive strand area between inner tubular cavities following one another in the extrusion direction.

24. (canceled)

25. An extrusion product in accordance with claim 22, wherein the extrusion product has one or more inner tubular cavities, which are closed at the end face, and which are arranged with an offset in relation to one another.

26-27. (canceled)

28. An extrusion product in accordance with claim 22, wherein the extrusion product has a board shape configuration.

29. (canceled)

30. A process for manufacturing an extrusion product with a extrusion press device from a material to be pressed, which has small loose plant parts provided with binder
pressing the loose material to be pressed, which is fed by means of an extrusion press;
forming the pressed material into a strand; and
feeding the strand, as a continuous strand, in an extrusion direction, wherein one or more inner tubular cavities are formed in the strand in the extrusion direction during extrusion, wherein the one or more inner tubular cavities are closed in the continuous strand at the end face with the material being pressed during the extrusion.

31. A process in accordance with claim 30, wherein the continuous strand has a respective massive strand area at one or both end faces of the one or more inner tubular cavities, that is formed during the extrusion.

32-35. (canceled)

36. A process in accordance with claim 30, wherein the strand is cut at right angles to the extrusion direction .
